(19) United States
(12) Patent Application Publication
(10) Pub. No.: US 2007/0033975 A1
(43) Pub. Date: Feb. 15, 2007

(54) Dual power protective device for power supply

(76) Inventor: Shun-Ming Liu, Banchiau City (TW)

Correspondence Address: Shun-Ming Liu, P.O. Box No. 6-57, Chung-Ho, Taipei, 235, TW

(21) Appl. No.: 10/369,545

(22) Filed: Feb. 21, 2003

(51) Int. Cl. E05B 27/08

(52) U.S. Cl. 70/491

(57) ABSTRACT

A lock cylinder includes a sliding fastening bolt, and an unlocking mechanism disposed in a housing. The characteristics thereof are that the unlocking mechanism is consisted of a fixed cylindrical block, a lock cylinder core and a pressing cylindrical block that are all provided with a plurality of corresponding orifices, respectively. A portion of the orifices at the fixed cylindrical block and the pressing pin cylindrical block is provided with spring pins and a pressing pin respectively. The lock cylinder core further impels the fastening bolt by an interlocking mechanism while a key is provided with an inserting pin for inserting into the orifice at the pressing cylindrical block to push the pressing pin inward that further pushes the spring pin into the orifice at the fixed cylindrical block, thus further turning the lock cylinder core and impelling the sliding fastening bolt for unlocking and obtaining an optimal anti-theft effect.

### BACKGROUND OF THE INVENTION

(a) Field of the Invention

The invention relates to a lock cylinder, and more particularly, to a lock cylinder comprising an unlocking mechanism consisted of a fixed cylindrical block, a lock cylinder core and a pressing pin cylindrical block, wherein an inserting pin of a key is inserted into an orifice at a spring pin cylindrical block to push a spring pin into an orifice of the fixed cylindrical block, thereby unlocking and locking the structure using a fastening bolt by turning the lock cylinder core.

(b) Description of the Prior Art

Common headlocks, bell locks or door locks, in principle, comprise a fastening bolt capable of up-and-down sliding movements and an unlocking mechanism disposed within a housing thereof. The unlocking mechanism is interlocked with the fastening bolt to lock windows or doors; whereas a key is inserted into the unlocking mechanism that subsequently releases the fastening bolt to unlock.

Prior unlocking mechanisms mostly comprise a single linear keyhole having balls as control elements for the lock, and the balls are disposed in irregularly linear arrangements on a same plane. Such designs are rather inadequate in anti-theft purposes for that these designs are commonly used and easily opened by thieves using thin and sharp objects.

Apart from the above, there are other available designs wherein the balls are disposed in irregular column arrangements instead of linear arrangements in a same plane. This three-dimensional arrangement is more complicated than the aforesaid planar arrangement, however, the balls yet act as the pressing and engagement element of the password thereof. Also, this design has unsatisfactory anti-theft functions because the balls disposed in column-shaped distributions have even more exposure to the exterior and are thus likely to be unlocked by thieves using thin and sharp objects.

In the view of the above, the invention provides a lock cylinder having a housing disposed with a sliding fastening bolt, and an unlocking mechanism disposed in the housing; and the characteristics thereof are that the unlocking mechanism is consisted of a fixed cylindrical block, a lock cylinder core and a pressing pin cylindrical block; wherein the fixed cylindrical block, the lock cylinder core and the pressing pin cylindrical block are provided with a plurality of corresponding orifices, respectively; a portion of the orifices at the fixed cylindrical block is provided with spring pins pressed against by springs, and the spring pins are partially or entirely extended into the orifices at the lock cylinder core that further impels the fastening bolt using an interlocking mechanism; a pressing pin is provided in the orifice at the pressing pin cylindrical block corresponding to the spring pin disposed in the fixed cylindrical block; and the key is provided with a corresponding inserting pin for inserting into the orifice at the pressing cylindrical block to push the pressing pin inward that further pushes the spring pin into the orifice at the fixed cylindrical block, thus further turning the lock cylinder core and impelling the sliding fastening bolt for unlocking and obtaining an optimal anti-theft effect.

### SUMMARY OF THE INVENTION

Therefore, an object of the invention is to provide a lock cylinder having an unlocking mechanism consisted of a fixed cylindrical block, a lock cylinder core and a pressing pin cylindrical block, wherein an inserting pin of a key is inserted into the orifice at the spring pin cylindrical block to push a spring pin into an orifice of the fixed cylindrical block, thereby unlocking and locking using a fastening bolt by turning the lock cylinder core for obtaining an optimal anti-theft effect.

### BRIEF DESCRIPTION OF THE DRAWINGS

FIG. 1 shows an elevational in accordance with the invention.

FIG. 2 shows a vertical sectional view in accordance with the invention.

FIG. 3 shows a horizontal sectional view illustrating the locked status in accordance with the invention.

FIG. 4 shows a horizontal sectional view illustrating the unlocked status in accordance with the invention.

FIG. 5 shows a sectional view of another embodiment in accordance with the invention.

FIG. 6 shows a sectional view illustrating the spring pins pressing against the press switch in FIG. 5.

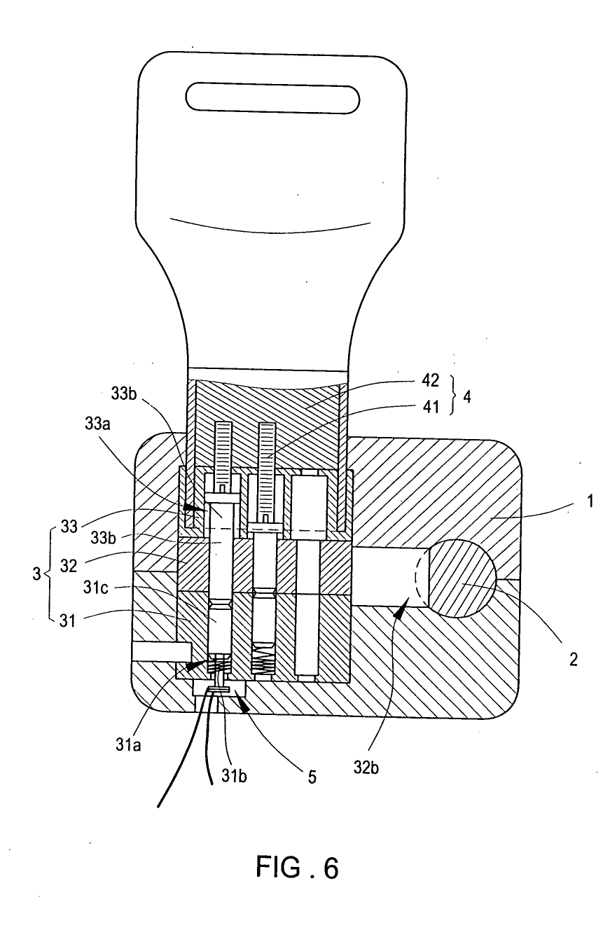

### DETAILED DESCRIPTION OF THE PREFERRED EMBODIMENTS

To better understand the invention, descriptions shall be given with the accompanying drawings hereunder.

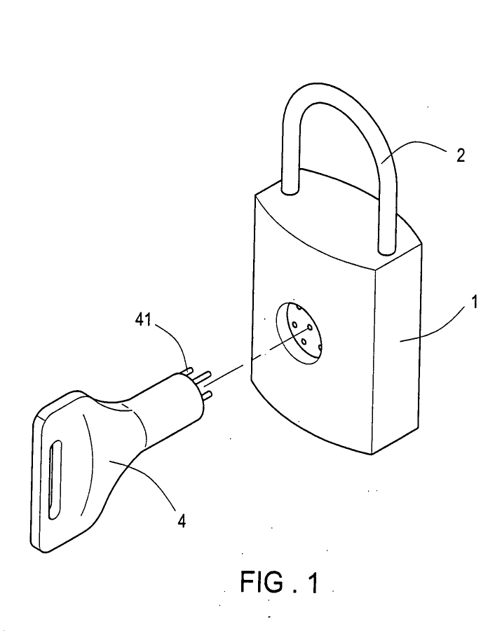

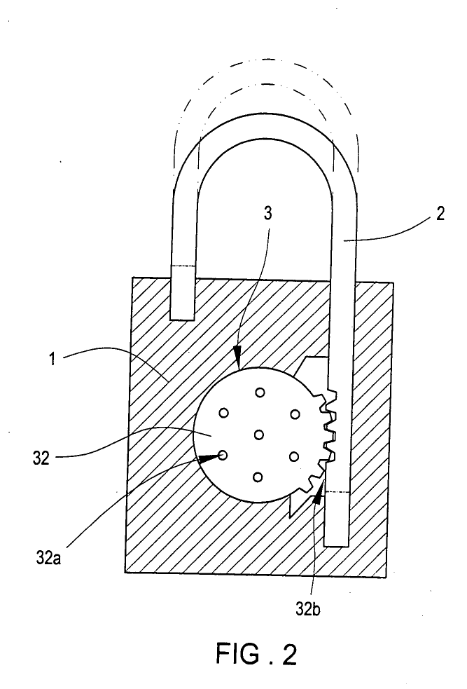

Referring to FIGS. 1, 2 and 3, the invention comprises a housing 1 disposed with a sliding fastening bolt 2, and an unlocking mechanism 3 provided in the housing 1; a key 4 is inserted into the unlocking mechanism 3 and turned for impelling sliding movements of the fastening bolt 2 so as to unlock; and the characteristics thereof are:
the unlocking mechanism 3 is consisted of a fixed cylindrical block 31, a lock cylinder core 32 and a pressing pin cylindrical block 33; wherein the fixed cylindrical block 31, the lock cylinder core 32 and the pressing pin cylindrical block 33 are provided with a plurality of corresponding orifices 31a, 32a and 33a, respectively; a portion of the orifices 31a at the fixed cylindrical block 31 is provided with spring pins 31c pressed against by springs 31b, and the spring pins 31c are partially or entirely extended into the orifices 32a at the lock cylinder core 32 that further impels the fastening bolt 2 using an interlocking mechanism 32b; a pressing pin 3b is provided in the orifice 33a at the pressing pin cylindrical block 33; and the key 4 is provided with a corresponding inserting pin 41 for inserting into the orifice 33a at the pressing pin cylindrical block 33 to push the pressing pin 33b inward that further pushes the spring pin 31c into the orifice 31a at the fixed cylindrical block 31, so as to withdraw the spring pin 31c from the orifice 32a at the lock cylinder core 32 and to further turn the lock cylinder core 32 and the pressing pin cylindrical block 33, thereby unlocking or locking using the lock cylinder core 32 through the sliding movements of the fastening bolt 2 impelled by the interlocking mechanism 32b.

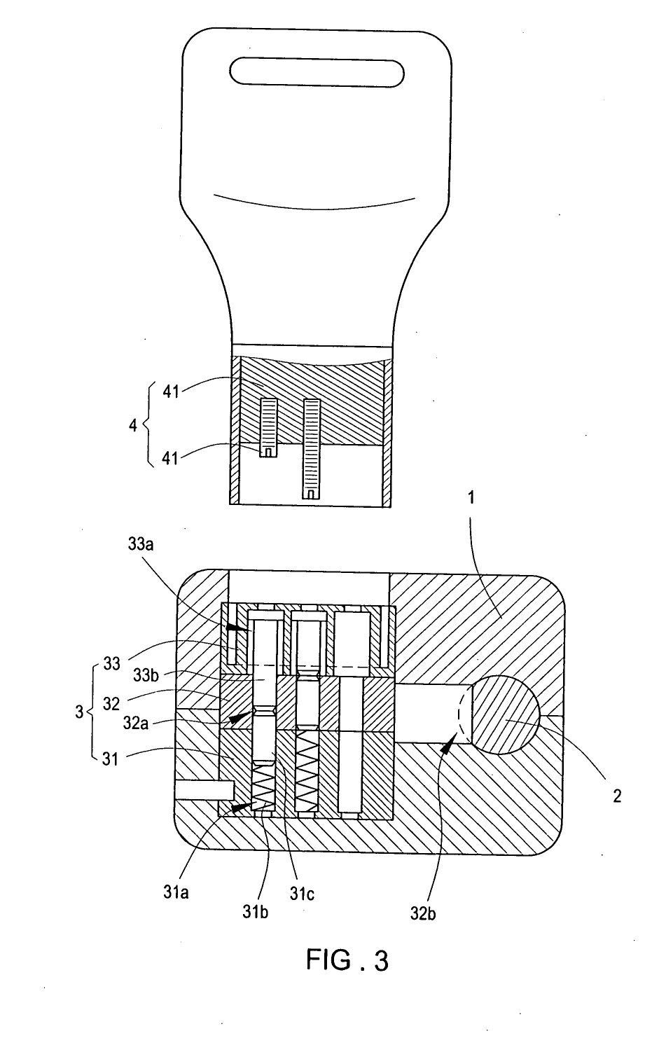

In accordance with the aforesaid structure, before inserting the key 4 into the unlocking mechanism 3, the spring pin 31c in the orifice 31a at the fixed cylindrical block 31 of unlocking mechanism 3 extends into the orifice 32a at the lock cylinder core 32 using forces of the spring 31b, and the pressing pin 33b in the orifice 33a of the pressing pin cylindrical block 33 presses against the spring pin 31c so that the spring pin 31c is positioned within the orifice 32a at the lock cylinder core 32. As a result, the lock cylinder core 32 is locked and becomes incapable of turning. In addition, for that the fastening bolt 2 is interlocked with the lock cylinder core 32 through the interlocking mechanism 32b, and therefore the fastening bolt 2 also becomes incapable of sliding when the lock cylinder core 32 cannot be turned. As a result, the structure changes into a locked status as shown in FIG. 3.

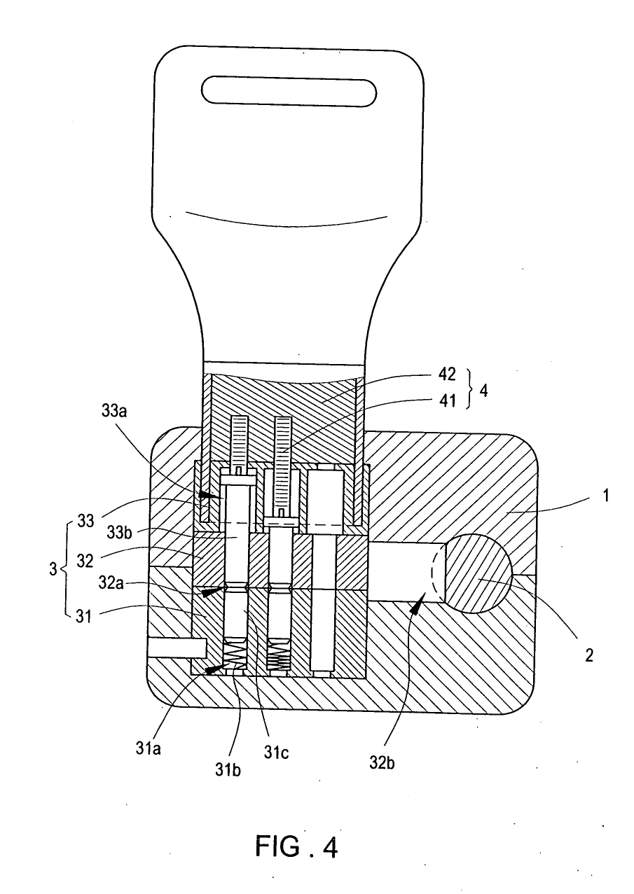

Vice versa, to unlock, the key 4 is inserted into the unlocking mechanism 3 such that the inserting pin 41 of the key 4 is inserted into the orifice 33a at the spring pin cylindrical block 33 to push the pressing pin 33b in the orifice 33a at the pressing pin cylindrical block 33 into the orifice 32a at the lock cylinder core 32. Because the pressing pin 33b and the spring pin 31c are disposed correspondingly, the spring pin 31c in the orifice 32a at the lock cylinder core 32 is consequently pushed back into the orifice 31a at the fixed cylindrical block 31 by the pressing pin 33b when the spring pin 33b is extended into the orifice 32a at the lock cylinder core 32. Resultingly, the spring pin 31c is entirely withdrawn from the orifice 32a at the lock cylinder core 32, and therefore even if the fixed cylindrical block 31 is separated from the lock cylindrical core 32, the pressing pin 33b of the pressing pin cylindrical block 33 is still extended into the orifice 32a at the fixed cylindrical block 31, such that the lock cylinder core 32 and the pressing pin cylindrical block 33 are combined into one body. In addition, the inserting pin 41 of the key 4 is inserted into the orifice 31a at the fixed cylindrical block 31, and hence the lock cylinder core 32 is turned by turning the key 4 and the fastening bolt 2 is impelled to slide using the interlocking mechanism 32b by turning the lock cylinder core 32, thereby unlocking the structure as shown in FIG. 4.

To obtain adaptions having more coding methods, the orifices 31a, 32a and 33a distributed at the fixed cylindrical block 31, the lock cylinder core 32 and the spring pin cylindrical block 33 may be regular or irregular arrangements, and the inserting pin 41 of the key 4 may have various lengths and diameters. Furthermore, the cylindrical spring pin 31c is used for positioning during unlocking, and it is made difficult to infer the positions thereof because of different lengths and complex distributions of the spring pins 31, thereby achieving an optimal anti-theft effect.

Referring to FIG. 3 or FIG. 4 showing that the inserting pin 41 of the key 4 is disposed and fastening to a key seat 42 by means of a sink screw. A key 4 having the same specifications may be used along with adjusting the length of the inserting pin 41 made of a sink screw in the replacement of the lost key 4.

In addition, the structure in accordance with the invention may be implemented in common locks, bell locks or door locks for obtaining the aforesaid effect.

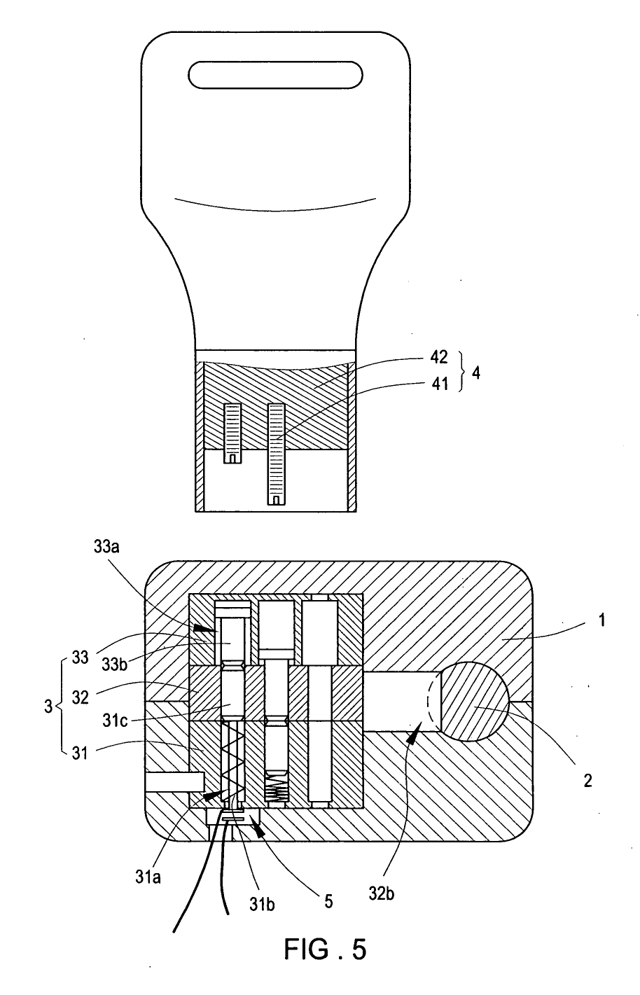

Referring to FIG. 5, the bottom of the orifice 31a at the fixed cylindrical block 31 of the unlocking mechanism 3 is disposed with a press switch 5 connected to an alarm (not shown in the diagram). For cases in which a correct key 4 is used for unlocking, the inserting pin 41 of the key 4 accurately pushes the pressing pin 33b and the spring pin 31c to precise positions; whereas thin and sharp objects or other keys 4 are used for unlocking, the spring pin 31c in the orifice 31a at the fixed cylindrical block 31 then presses against the press switch 5 due to incorrect key codes, and further powers on the press switch to activate the alarm clock, thereby obtaining an even better anti-theft effect.

Also, if the number of the orifices 31a, 32a and 33a at the fixed cylindrical block 31, the lock cylinder core 32 and the pressing pin cylindrical block 33 is N, the number of arrangement combinations shall equal to N^{N}. Therefore, the more the number of the orifices, the more code combinations there are, and the harder it is for the thieves to crack the codes, and thus elevating the anti-theft effect.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A lock cylinder having housing disposed with a sliding fastening bolt, and an unlocking mechanism disposed in the housing; a key is used to inserted into and turn in the unlocking mechanism to impel the sliding fastening bolt for unlocking or locking; and the characteristics thereof are:
the unlocking mechanism is consisted of a fixed cylindrical block, a lock cylinder core and a pressing pin cylindrical block; wherein the fixed cylindrical block, the lock cylinder core and the pressing pin cylindrical block are provided with a plurality of corresponding orifices, respectively; a portion of the orifices at the fixed cylindrical block is provided with spring pins pressed against by springs, and the spring pins are partially or entirely extended into the orifices at the lock cylinder core that further impels the fastening bolt using an interlocking mechanism; a pressing pin is provided in the orifice at the pressing pin cylindrical block corresponding to the spring pin disposed in the fixed cylindrical block; and the key is provided with a corresponding inserting pin for inserting into the orifice at the pressing pin cylindrical block to push the pressing pin inward that further pushes the spring pin into the orifice at the fixed cylindrical block, so as to withdraw the spring pin from the orifice at the lock cylinder core and to further turn the lock cylinder core and the pressing pin cylindrical block, thereby unlocking or locking using the lock cylinder core through the sliding of the fastening bolt impelled by the interlocking mechanism.

2. The lock cylinder in accordance with claim 1, wherein the inserting pin of the key disposed and fastened onto a key seat by means of a sink screw.

3. The lock cylinder in accordance with claim 1, wherein the bottom of the orifice at the fixed cylindrical block of the unlocking mechanism is provided with a press switch connected to an alarm.
